(19) United States
(12) Patent Application Publication
(10) Pub. No.: US 2025/0378756 A1
(43) Pub. Date: Dec. 11, 2025

(54) IMAGE PROCESSING METHOD FOR DETERMINING A TRAVEL SPEED OF A VEHICLE, COMPUTER PROGRAM AS WELL AS IMAGE PROCESSING DEVICE FOR IMPLEMENTING THE IMAGE PROCESSING METHOD

(71) Applicant: Robert Bosch GmbH, Stuttgart (DE)

(72) Inventors: Moritz Michael Knorr, Hildesheim (DE); Gregor Blott, Salzgitter (DE); Nils Zerrer, Eindhoven (NL); Florian Richter, Lamspringe (DE); Emil Schreiber, Hannover (DE); Sven Wagner, Ihlow (DE); Andreas Wellhausen, Elze (DE); Matthias Kirschner, Hildesheim (DE)

(21) Appl. No.: 19/226,352

(22) Filed: Jun. 3, 2025

(30) Foreign Application Priority Data
Jun. 5, 2024 (DE) 10 2024 205 178.0

(51) Int. Cl. G08G 1/052; G06V 10/75; G06V 20/52; G08G 1/01

(52) U.S. Cl. CPC G08G 1/052; G06V 10/751; G06V 20/52; G08G 1/0116; G06V 2201/08

(57) ABSTRACT

An image processing method for determining a travel speed of a vehicle. A monitoring scene with at least one vehicle is arranged in the monitoring region, where at least a first image of the monitoring scene is detected. A first time stamp is assigned to the first image, and a second image of the monitoring scene is detected, a second time stamp is assigned to the second image, and a first polyhedron is derived from the first image and a second polyhedron is derived from the second image. The first and the second polyhedron each represent the vehicle. Vehicle size information is determined for the first polyhedron and/or for the second polyhedron, A distance travelled by the vehicle in the monitoring region is established based on the vehicle size information and the polyhedrons, and the vehicle speed is established based on the distance and the time stamp.

### BACKGROUND

The invention relates to an image processing method for determining a travel speed. The invention also relates to a corresponding computer program as well as an image processing device for implementing the image processing method.

Monitoring the speeds of different road users on highways, at intersections or in parking garages is a fundamental objective of intelligent traffic monitoring systems.

A static and calibrated camera system is usually required for camera-based speed estimation. Calibration means that the position and orientation of the camera in relation to the road and the intrinsics of the camera are known, which is used to estimate metric values.

### SUMMARY

The invention relates to an image processing method for determining a travel speed. The invention also relates to a computer program as well as to an image processing device. Further features and advantages of the invention are apparent from the disclosure, the following description and the accompanying Figures.

The object of the invention is an image processing method for determining a travel speed of a vehicle in a monitoring region. A monitoring scene with at least one vehicle may be arranged in the monitoring region. The vehicle is in particular a road vehicle, more concretely a passenger car, truck, bus, etc. The monitoring scene is configured in particular as a travel area of vehicles. The monitoring scene may be realized in particular as a road, a highway, an intersection, a parking lot or the like.

The travel speed is configured as an absolute speed in the in particular real monitoring region and is specified, for example, in kilometers/hour or mph.

At least a first image and a second image of the monitoring scene are detected. In particular, the detection is carried out by a camera. The camera is configured as a monitoring camera, for example. It is thus possible that the monitoring camera is implemented as a black-and-white camera or as a color camera. From a technical point of view, it may be a CCD or CMOS camera. In particular, the camera comprises a lens, wherein the monitoring scene in the monitoring region is imaged onto a sensor, which generates the first and second images.

A time stamp is assigned to each of the first and second images. The time stamp may be relative information, so that a time difference between the first and second image can be derived. Alternatively, it may be absolute information that represents the current time in the monitoring region, optionally additionally with the date. The time stamp may already have been assigned to the images by the camera; alternatively, the time stamp is applied in real time during a subsequent evaluation or during the transmission of the images. In particular, the time stamp represents the time at which the images were captured.

A first polyhedron is derived from the first image and a second polyhedron is derived from the second image, wherein the first and second polyhedron each represent the same vehicle. In particular, the same definitions for deriving, in particular generating, the polyhedrons are applied to the first and second image.

For example, a polyhedron position may be defined on the basis of the polyhedron. The polyhedron position may, for example, be a center of gravity or a center of gravity or center point of the polyhedron projected onto the base surface, preferably the polyhedron position is configured as a corner point, center point or base point of the polyhedron.

Vehicle size information is determined for the first and/or second polyhedron. The determination may be made with the derivation of the first polyhedron and/or of the second polyhedron. Alternatively, the determination may be made subsequently. The vehicle size information comprises at least one or exactly one vehicle size in one dimension. Alternatively, the vehicle size information may comprise exactly two vehicle sizes in two independent dimensions. It is particularly easy for further processing of the data if the vehicle size information comprises exactly three vehicle sizes in three independent dimensions. The vehicle size information and/or the vehicle size is configured in particular as an absolute measure of length in the in particular real monitoring region and is specified, for example, in meters or centimeters

The vehicle size information is particularly preferably configured as a vehicle height, vehicle width and/or vehicle length. In the event that only one dimension is used, one measure of length is thus used; in the event that exactly two dimensions are used, two measure of lengths are thus used; in the event that three dimensions are used, all three measure of lengths are used.

In particular, the vehicle size information forms a basis for converting the polyhedron sizes or portions thereof from pixels into absolute measure of lengths. In other words, through the joint consideration, in particular calculation, of polyhedron and vehicle size information, a real size of the polyhedrons in the monitoring region is known and/or can be established.

A distance of the vehicle in the monitoring region between the time stamps and/or between the first and second image is established on the basis of the vehicle size information and the polyhedrons. This is possible, since the distance in the monitoring region can also be deduced from the real size in the monitoring region by knowing the measure of lengths or the measure of length and the geometry of the polyhedrons. The distance is configured in particular as an absolute measure of length in the in particular real monitoring region and is specified in meters or centimeters, for example.

The vehicle speed can be established on the basis of the established distance and the time stamp by dividing the distance as a route by the time difference between the time stamps.

The invention has the advantage that an image-based speed measurement can be implemented with an uncalibrated camera system. Calibration is replaced by the addition of the vehicle size information. In particular, some or all of the following advantages can be achieved:

Simplified commissioning of the camera or image processing system, since there is no need for time-consuming calibration. Changes to the camera pose (e.g. due to environmental influences such as wind) do not lead to errors in the speed estimation. Systems based calibration, on the other hand, need to be recalibrated in order to make valid estimates. Changes in camera intrinsics (e.g. due to temperature fluctuations) are taken into account for each measurement. Systems with static calibration parameters do not take this into account and are less robust. By using polyhedron detections, vehicles are detected more precisely in the image compared to conventional 2D detections, which enables more accurate motion estimation

It is particularly preferred that the polyhedron completely encloses the vehicle and/or that the vehicle is completely arranged in the polyhedron, including any attachments.

In particular, coordinates are derived, wherein the coordinates define projected corner points of the polyhedron in the image. The coordinates are configured in particular as image coordinates and/or as 2D coordinates and represent points in the image on or in the image plane. In particular, eight corner points are established, which define six side surfaces (front, rear, top, bottom, left, right in the direction of travel). Depending on the geometry of the vehicle, there may not necessarily be right angles. However, the polyhedron preferably encloses the vehicle in such a way that neither parts of the vehicle protrude beyond the polyhedron, nor that it is too large so that there is a ‘gap’ between the polyhedron and the vehicle. In particular, the polyhedron is configured with six side faces, especially as a cuboid and particularly preferably as a rectangular cuboid. The polyhedron represents the vehicle.

The determined coordinates may include eight corner points of the cuboid and thus describe it by definition. Alternatively, only four corner points of the cuboid are determined, wherein the four corner points of the cuboid do not lie in a common plane, and the eight corner points of the cuboid are inferred by linear combination of the four corner points.

In a preferred realization of the invention, the coordinates are configured as p3D coordinates. In particular, this is in particular the projection of the eight (3D) corner points of the polyhedron enclosing the vehicle in the image. As a frame projection, the p3D coordinates are the projection into the image of a polyhedron (imagined in the real world) preferably directly surrounding the object, in particular a cuboid configured as a 3D frame. The 3D frame and/or the polyhedron, in particular cuboid, is formed in particular by straight line portions. ‘Immediately surrounding’ is to be understood in such a way that a surface defined by the imaginary 3D frame or cuboid (e.g. polyhedron defined by the frame) surrounds the vehicle tightly/as tightly as possible, for example with the smallest possible volume. The respective surfaces and edges of the surface spanned by the 3D frame or cuboid touch the surface of the object. In other words, a so-called ‘3D-bounding box’ is established in particular as a 3D frame or cuboid. The 3D frame is, for example, an enveloping body in the form of a rectangular cuboid.

In a preferred further development of the invention, the images are captured and/or selected in such a way that the distance of the vehicle position between the two images is configured to be less than 5 m, preferably less than 2 m. This ensures that a realistic distance is established even when cornering. It is particularly preferable if a plurality of images is captured, wherein the vehicle is tracked using a tracking module, for example, so that the vehicle speed can be determined more accurately. A trajectory of the vehicle is thus determined, wherein a local vehicle speed can be calculated between the respective vehicle positions, which can subsequently be combined for the trajectory to form a common, in particular averaged vehicle speed.

It is preferred that the vehicle size information is provided as additional information, in particular independent additional information. The vehicle size information is taken in particular from a reference work, in particular from a database.

In a first embodiment of the invention, the vehicle size information is determined assuming a standard size of the vehicle. In other words, a unit size is used for all vehicles.

In a possible further development, a vehicle class of the vehicle is determined first. The vehicle class may, for example, relate to passenger cars, trucks, trucks with trailers, buses, heavy transporters, etc. The vehicle class of the vehicle may be determined using digital image processing and known pattern recognition. Alternatively, an in particular deep neural network may be used to recognize the vehicle class. Other machine learning techniques may also be used. Depending on the vehicle class, a standard size of the vehicle of the vehicle class is used as vehicle size information. The standard size of the vehicle class trucks is therefore larger than the standard size of the vehicle class passenger cars. Further subdivisions of the vehicle class are possible.

In the above-mentioned embodiments, the vehicle size information, i.e. the respective standard size, is provided as independent additional information, for example taken from a database or a set of rules.

In a possible further development of the invention, the vehicle model, in particular comprising the vehicle variant, of the vehicle is determined, wherein the vehicle size information is queried from a database on the basis of the vehicle model. Here, the division into vehicle classes is further refined, i.e. to the vehicle models. The determination of the vehicle model may be carried out using the same techniques as the determination of the vehicle class, so that reference is made to the previous description.

It is also possible that the vehicle size information is not provided as independent additional information, but is estimated from the images or the image. This may be implemented in particular using digital image processing or machine learning methods, such as an in particular deep neural network.

In the image processing method, assumptions are made that are always fulfilled in typical use cases:
a. In general, it is assumed that the (unknown) intrinsic calibration of the camera locally (i.e. in the image region in which the vehicle is located at the time of capturing) has approximate perspective effects (i.e. is distortion-free).
b. It is also assumed that the corner points of the polyhedron in the two images are in the same physical position relative to the vehicle. For example, a point of the polyhedron may be laterally at the height of the exterior mirror and longitudinally at the height of the license plate and vertically at the height of the roof in the air OR may be offset by an arbitrary value (e.g. 10 cm in the direction of the license plate). However, this offset has to be exactly the same for both images.

In a possible further development of the invention, a pixel offset is calculated between the polyhedrons in the images, wherein the pixel offset is converted into the distance in the monitoring region on the basis of the polyhedrons and the vehicle size information. In this way, the distance can be determined using the pixel offset and the other known parameters. It is assumed here that the vehicle moves in an approximate linear fashion (i.e. does not make any sharp curves). It is furthermore assumed that the image coordinates of the polyhedron (or p3D box in particular) are available.

Without pseudo-calibration:

A length in the direction of travel (e.g. vehicle length or wheelbase) as vehicle size information:

If a length in the direction of travel is given, i.e. on the polyhedron, there is an edge that points in the direction of travel (straight ahead) and whose length is known, the speed can be determined using 1D homography (see, for example, ‘Multiple View Geometry in Computer Vision, second edition’ (page 44)).

Two lengths in a plane parallel to the ground plane/roadway that are not parallel and a known angle between the length-measuring lines. The polyhedron also has to have at least four corner points in the plane (e.g. vehicle width and vehicle diagonal length):

If two lengths are known that measure non-parallel line segments and the corresponding points of the polyhedron lie in a plane that is parallel to the driving plane, the speed can be determined using a 2D homography decomposition. An example of this would be the width and diagonal of a rectangle surrounding the vehicle on the ground plane.

Alternatively, a local pseudo-calibration can be carried out using the known metric values, in particular the vehicle size information, and the polyhedron.

For the pseudo-calibration, it is assumed that a possible global distortion (which does not change significantly locally) is isotropic, i.e. does not lead to unequal compression/stretching along the two image axes assigned to the first and second image. In the pseudo-calibration, a calibration matrix K is estimated from the corner points and corresponding line segments of the polyhedron, which is valid for the local image. This matrix contains a focal length and a principal point. Assumption (a.) implies that the focal lengths can be assumed to be the same for both imaging directions (local), i.e. there is no different focal length in the x and y directions, for example. If the intrinsic calibration of the camera is known, any distortion etc. may of course be present. The pseudo-calibration may, for example, be determined using the vanishing points as the main points, which result from the parallel lines of the polyhedron, in particular the p3D box. This utilizes the fact that the axes of the polyhedron, in particular the p3D box, are perpendicular to each other and parallel in the world. In this case, it is possible to determine the distance traveled from any length between two polyhedron points in the plane or in the case of a point in the plane and another point perpendicular to it. The name pseudo-calibration was chosen to make it clear that the calibration does not have to be valid for the entire image area of the camera.

A further object of the invention relates to a computer program. A further, optional object of the invention relates to a digital storage medium, wherein the computer program is stored on the storage medium.

A further object of the invention relates to an image processing device configured to implement the image processing method as described above.

The image processing device is configured in particular as a digital data processing device, such as a computer, a cloud instance, etc.

The image processing device comprises an input interface for transferring the images from a camera, wherein a time stamp is assigned to the images. Optionally, the camera forms a component of the image processing device. The time stamp may be applied by the camera and/or by the image processing device.

The image processing device has a determination apparatus for determining the polyhedron and the vehicle size information. The image processing device may have several modules, wherein, for example, a polyhedron module is provided first, which determines the polyhedron in the images. Subsequently, a size determination module may be provided, which establishes the vehicle information. The polyhedron module may, for example, be based on digital image processing, and the size determination module may comprise a database and/or a set of rules. Alternatively, the polyhedron module of the size determination module may also be configured as an artificial intelligence, in particular a neural network, which determines the polyhedron and the vehicle information.

Furthermore, the image processing device has an evaluation apparatus for determining the vehicle speed by establishing the distance of the vehicle in the monitoring region and calculating it with the time stamps.

Optionally, the image processing device has a tracking module which, in the case of a plurality of images, tracks the vehicle along a trajectory, in particular follows it, and establishes a plurality of local vehicle speeds between the images and summarizes a common, in particular averaged vehicle speed for the trajectory or portions thereof.

### BRIEF DESCRIPTION OF THE DRAWINGS

Further advantages and features of the invention are apparent from the following description of a preferred configuration example and the accompanying Figures. These show:

FIG. 1 shows a schematic block diagram of an image processing device and an illustration of the corresponding process;

FIG. 2 shows a schematic representation of a monitoring scene in a monitoring region with a vehicle to which a polyhedron has been assigned.

### DETAILED DESCRIPTION

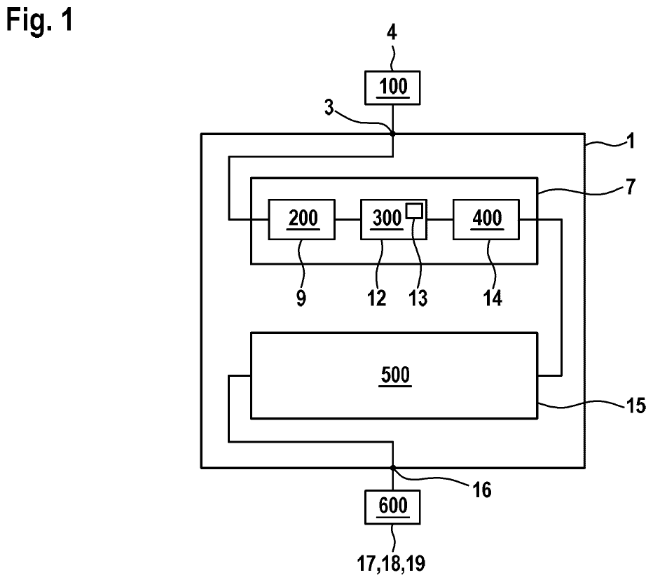

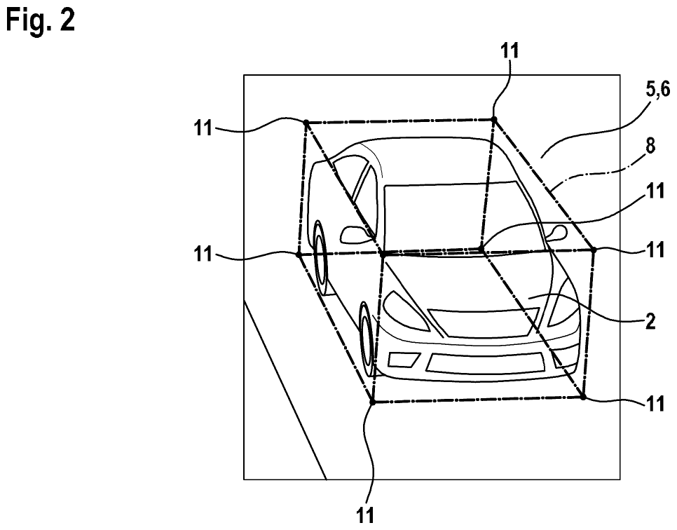

FIG. 1 shows a schematic block diagram of an image processing device 1 for implementing a method for determining a travel speed of a vehicle 2 (FIG. 2). The image processing device 1 is configured, for example, as a digital data processing device, such as a computer or an instance in the cloud.

The image processing device 1 has an input interface 3 for receiving images, in particular a first and a second image, from a camera 4. The camera 4 is directed toward a monitoring region 5 (FIG. 2), which shows a monitoring scene 6 (FIG. 2) with the vehicle 2. Optionally, the camera 4 forms a component of the image processing device 1. Preferably, the camera 4 is stationary during the execution of the method and/or has a stationary field of view. In a step 100, the images are captured and/or provided to the image processing device 1.

The image processing device 1 has a determination apparatus 7, wherein the images are routed from the camera 4 to the determination apparatus 7. Optionally, a time stamp is assigned to the images by the camera 4 or by the determination apparatus 7 or at another location, which makes it possible to determine a time interval between the images. For example, the time stamp is configured as absolute information, for example Central European Time with a date, or as relative information, so time information between the images can be determined.

The determination apparatus 7 is configured to determine a polyhedron 8 (FIG. 2) and vehicle size information for the polyhedron 8 from the images for the vehicle 2.

In principle, the determination apparatus 7 may, for example, be configured as a black box, such as a neural network or an AI, which determines the polyhedrons 8 and the vehicle size information via the neural network or the other AI. In the configuration example shown, the polyhedrons 8 are determined via digital image processing in a polyhedron module 9.

In a step 200, the polyhedron module 9 determines the polyhedrons 8 from the images. In particular, each of the images shows the vehicle 2, but at different vehicle positions. In particular, a first and a second image are provided, wherein a first polyhedron 8 is determined in the first image and a second polyhedron 8 is determined in the second image. The first and the second polyhedron 8 or generally the polyhedrons 8 each represent the vehicle 2 at the different vehicle positions.

FIG. 2 shows such an image, wherein the polyhedron 8 is graphically superimposed. The polyhedron 8 is configured as a rectangular cuboid and tightly encloses the vehicle. FIG. 2 shows such a representation schematically, which shows a monitoring region 5 with the monitoring scene 6 in the form of a road with the vehicle 2. The vehicle 2 is enclosed in the polyhedron 8, wherein it can be seen that the polyhedron 8 completely encloses the vehicle 7 on the one hand, so that the polyhedron 8 forms a contour representing the vehicle 7. On the other hand, the polyhedron 8 is positioned as closely as possible around the vehicle 2 so that no excessively large contour is defined. It should be emphasized that the polyhedron 8 is only oriented to the outer dimensions of the vehicle 2, but does not require any other key points. The polyhedron 8 is configured as a rectangular cuboid, which is defined by corner points 11 in image coordinates. In particular, so-called p3D coordinates are used.

The determination apparatus 7 has a size determination module 12 which is configured to determine, in a step 300, vehicle size information for the polyhedrons 8, in particular for the first and second polyhedrons 8. There are various possibilities for this:

In principle, the size determination module 12 accesses a database 13—also known as a set of rules—wherein the vehicle size information is stored in the database 13. The database 13 may be locally arranged, but it may also be located in the cloud. The vehicle size information is thus provided as additional information to the images, in particular independent additional information, or as a priori knowledge.

On the one hand, it is possible that the vehicle size information is determined under the assumption of a standard size of the vehicle 2. In this case, each vehicle is estimated equally. This embodiment is comparatively inaccurate, but may be sufficient if the corresponding vehicles 2 are each approximately the same size.

Alternatively, a vehicle class of the vehicle 2 is determined, wherein the vehicle size information is determined assuming a standard size of the vehicle class. Thus, different vehicle size information is taken from the database 13, depending on whether the vehicle 2 is configured as a passenger car, motortruck, bus, truck, truck with trailer, etc.

In another alternative configuration example, the vehicle model, in particular including the vehicle variant, is determined, wherein the vehicle size information is queried from the database 13 on the basis of the vehicle model. This method is particularly accurate, since corresponding vehicle size information can be used for each vehicle model.

In other embodiments, the vehicle size information is estimated from the images, so that such a database 13 can be dispensed with.

The polyhedron module 9 may determine the polyhedron 8 using digital image processing, for example. The determination of the vehicle class or the vehicle model may also be implemented via digital image processing, in particular via pattern recognition. Alternatively, a corresponding neural network or a corresponding AI is used, which has previously been trained with polyhedrons, vehicle classes or vehicle models.

Images of vehicles with a known polyhedron, a known vehicle class or a known vehicle model are thus used as training data, which are labeled, for example, so that the neural network or the other AI can be trained in a simple, known manner.

It is possible to determine the vehicle speed of vehicle 2 using only two images. Preferably, however, a plurality of images are used, wherein a trajectory of the vehicle 2 can be formed. The trajectory is formed in a step 400 in a tracking module 14. Here, vehicles 2 from successive images are each assigned to the same vehicle 2. The trajectory then comprises various vehicle positions, wherein the local vehicle speed or a common vehicle speed is determined for two consecutive images or for the entire trajectory, as explained below. The tracking module 14 or the step 400 may also be arranged in terms of data technology before the size determination module 12 and thus before the step 300. For each vehicle 2 in the images of the trajectory, the vehicle information in principle only has to be determined once, since the vehicle information is absolute information of the respective vehicle 2.

In principle, the vehicle size information may only be available in one dimension, so that, for example, only one vehicle length, one vehicle width or one vehicle height or another measure of length is used. In more precise methods, at least or an exact measure of lengths for two independent dimensions are determined as vehicle size information. The method is particularly simple and particularly accurate if measures of lengths are available for all three independent dimensions, so that, for example, the vehicle length, the vehicle width and the vehicle height are available as vehicle size information, which can then be offset against the polyhedrons 8.

The vehicle size information and the polyhedrons are passed to an evaluation apparatus 15 of the image processing device 1 for a step 500. The evaluation apparatus 15 is configured to perform step 500, wherein a distance of the vehicle 2 in the monitoring region between the time stamps is established knowing the vehicle information and the polyhedron 8.

The vehicle speed is then established on the basis of the established distance between two images and the time difference between the time stamps of the images. If a trajectory has been determined, local vehicle speeds between the images and a common vehicle speed or a common speed profile of the vehicle 2 along the trajectory are determined.

The image processing device 1 has an output interface 16 which is configured to output, in a step 600, the vehicle speed, possibly with identification data for identifying the vehicle 2, as well as optionally the images to a monitoring center 17, another database 18 or to a display device 19 for further processing, for example for traffic monitoring.

1. An image processing method for determining a travel speed of a vehicle (2) in a monitoring region (5), wherein a monitoring scene (6) with at least one vehicle (2) may be arranged in the monitoring region (5),
wherein at least a first image of the monitoring scene (6) is detected, wherein a first time stamp is assigned to the first image, and wherein a second image of the monitoring scene (6) is detected, wherein a second time stamp is assigned to the second image (100),
wherein a first polyhedron (8) is derived from the first image and a second polyhedron (8) is derived from the second image, wherein the first and the second polyhedron each represent the vehicle (2) (200),
wherein a vehicle size information is determined for the first polyhedron and/or for the second polyhedron (300),
wherein a distance traveled by the vehicle (2) in the monitoring region (5) between the time stamps is established on the basis of the vehicle size information and the polyhedrons (8), wherein the vehicle speed is established on the basis of the distance and the time stamp (500).

2. The image processing method according to claim 1, wherein the polyhedrons (8) enclose the vehicle (2).

3. The image processing method according to claim 1, wherein the polyhedrons (8) are determined in p3D coordinates.

4. The image processing method according to claim 1, wherein the distance of the vehicle (2) between the two images is configured to be less than 5 m, preferably less than 2 m.

5. The image processing method according to claim 1, wherein the vehicle size information is determined assuming a standard size of the vehicle (2).

6. The image processing method according to claim 1, wherein a vehicle class of the vehicle (2) is determined and the vehicle size information is determined assuming a standard size of the vehicle class.

7. The image processing method according to claim 1, wherein the vehicle model of the vehicle (2) is determined, wherein the vehicle size information is queried from a database (13) on the basis of the vehicle model.

8. The image processing method according to claim 1, wherein the vehicle size information is estimated from the images.

9. The image processing method according to claim 1, wherein the distance traveled is determined by converting the pixel offset of the polyhedrons (8) in the images.

10. The image processing method according to claim 1, wherein a local pseudo-calibration with a calibration matrix is carried out for each of the polyhedrons (8), wherein the distance traveled is determined on the basis of the calibration matrices and the vehicle size information.

11. A computer program, wherein the computer program is configured and/or arranged to execute, apply and/or implement in its execution the image processing method according to claim 1.

12. An image processing device (1) configured to implement the image processing method according to claim 1, and further comprising:
an input interface (3) for transferring the images from a camera (4), wherein a time stamp is assigned to the images,
a determination apparatus (7) for determining the polyhedrons (8) and the vehicle size information, and
an evaluation apparatus (15) for determining the vehicle speed by establishing the distance of the vehicle (2) in the monitoring region (5) between the images and calculating the time stamp of the images.
